(19) United States
(12) Patent Application Publication
(10) Pub. No.: US 2011/0186133 A1
(43) Pub. Date: Aug. 4, 2011

(54) Apparatus and method for preventing ice formation on the surface of water

(76) Inventors: A. Dale Hiatt, JR., Colorado Springs, CO (US); Henry D. Hiatt, Parker, CO (US)

(21) Appl. No.: 12/931,259

(22) Filed: Jan. 27, 2011

Related U.S. Application Data
(60) Provisional application No. 61/337,507, filed on Feb. 4, 2010.

(51) Int. Cl. A01K 97/01; F04B 35/04

(52) U.S. Cl. 137/1; 417/410.1; 43/4

(57) ABSTRACT

An air pump is employed to inject an adjustable flow of air into the column of water within an ice fishing hole to create air bubbles that naturally rise to the surface of the water as the result of air being lighter than water. The rising air bubbles create an upward flow or circulation of water within the hole, replacing colder water at the surface of the hole with warmer water from near the bottom of the hole to thereby prevent formation of ice on the surface of the column of water. The present apparatus and method may be similarly employed to maintain livestock water tanks and other contained volumes of water free of ice.

### REFERENCE TO RELATED APPLICATION

This application incorporates the subject matter and claims the benefit of U.S. Provisional Patent Application Ser. No. 061/337,507 filed on Feb. 4, 2010.

### BACKGROUND AND SUMMARY OF THE INVENTION

This invention relates generally to ice formation on contained bodies of water and, more particularly, to an apparatus and method for preventing the formation of ice over holes previously drilled in lake ice for use in ice fishing, as well as over other contained volumes of water for use in agricultural and industrial applications.

The formation of ice on the surface of water is a problem for ice fisherman as well as for agricultural workers who must maintain a source of drinking water for livestock. Ice fisherman routinely drill or dig holes through thick ice on lakes in order to present lures or bait to fish swimming beneath the ice. These holes must be continuously skimmed in order to remove ice that forms on the surface. Maintaining the holes clear of ice can be a repetitious and time consuming task, depending on ambient wind and temperature conditions.

Attempted solutions to the problem of ice formation over a hole previously drilled through a layer of ice are known in the prior art. U.S. Patent Application Publication No. 2004/0068914 of Wellard et al. is directed to a mechanical ice skimmer device. U.S. Patent Application Publication No. 2007/0187145 of Periard is directed to a heatable ice perforation device. U.S. Pat. No. 3,289,850 to Gubash is direct to a mechanical ice skimmer. U.S. Pat. No. 3,747,253 to Gangi et al. is directed to a combination tool for fishermen that includes a spoon member for removing ice from an ice fishing hole. U.S. Pat. No. 3,857,787 to Kinne is directed to a mechanical ice skimmer. U.S. Pat. No. 4,006,732 to Schumm is directed to an ice fishing heater that is intended to maintain an ice fishing hole free of ice. U.S. Pat. No. 5,564,213 to Rinehart is directed to a fold-up ice fishing rig. U.S. Pat. No. 6,981,346 to Wiezycki is directed to a mechanical ice fishing hole strainer device. U.S. Pat. No. 6,907,689 to Pendzimas is directed to an ice fishing strainer assembly. U.S. Pat. No. 6,694,662 to McClure is directed to a mechanical ice-skimming device.

It would be advantageous to provide an apparatus and method for preventing the formation of ice on the surface of water exposed within a hole drilled through a thickness of ice for ice fishing purposes and for preventing ice from forming on other contained volume of water used for agricultural or industrial purposes.

In accordance with the illustrated preferred embodiment of the present invention, an air pump is employed to inject an adjustable flow of air into the column of water within an ice fishing hole to create air bubbles that naturally rise to the surface of the water as the result of air being lighter than water. The rising air bubbles create an upward flow or circulation of water within the hole, replacing colder water at the surface of the hole with warmer water from near the bottom of the hole to thereby prevent formation of ice on the surface of the column of water. The apparatus and method of the present invention may be similarly employed to maintain livestock water tanks and other contained volumes of water free of ice. The air pump is driven by an electric motor that may be powered by any of a number of conventional external power sources, such as a battery, an AC source, or a solar panel. The air pump and motor may be mounted in an enclosure along with power conversion circuitry capable of generating sufficient heat within the enclosure to insure proper functioning of the motor and air pump in very cold ambient temperatures.

### BRIEF DESCRIPTION OF THE DRAWINGS

FIG. 1 is a pictorial cross-sectional diagram illustrating a typical ice fishing hole drilled through a thick layer of snow-covered ice on a body of water.

FIG. 2 illustrates the ice fishing hole of FIG. 1 with an undesirable layer of ice formed on the surface of the column of water within the ice fishing hole.

FIG. 3 illustrates the temperature gradient of the column of water within the ice fishing hole of FIGS. 1 and 2 and the desired movement of warmer water upward toward the surface thereof.

FIG. 4 is a block diagram of the components that form the apparatus of the present invention.

FIG. 5 illustrates the upward movement of air bubbles in the column of water within the ice fishing hole of FIGS. 1-3, produced by the apparatus of the present invention, and the accompanying circulation of warmer water from the bottom of the column of water to the top surface thereof to thereby prevent the formation of ice on that surface.

FIG. 6 is a pictorial cross-sectional diagram illustrating use of the apparatus of the present invention in a contained body of water such as a livestock water tank or a small pond, for example, to prevent the formation of ice on the surface of the water.

### DESCRIPTION OF THE PREFERRED EMBODIMENT

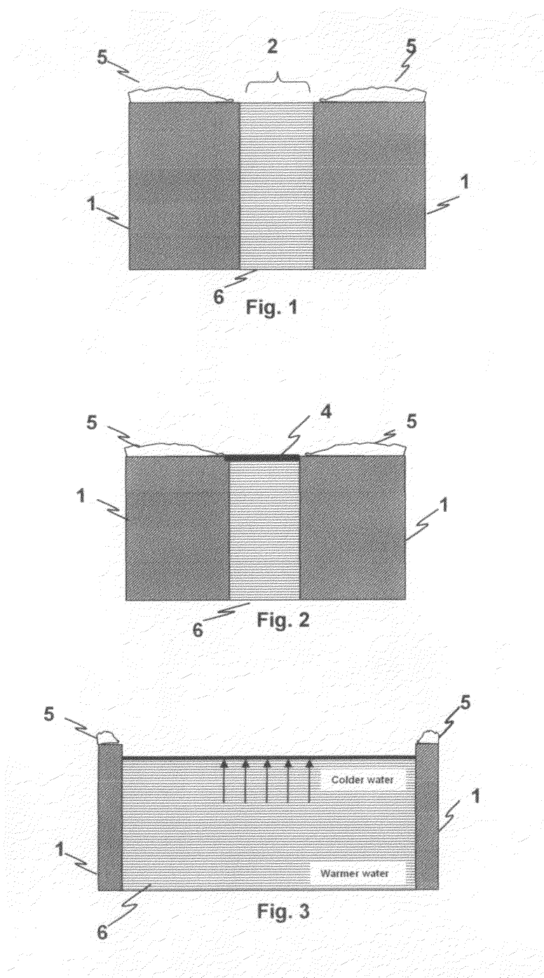

Referring now to FIG. 1, there is shown a pictorial cross-sectional diagram illustrating an ice fishing hole 2 of any chosen shape or size previously drilled through a layer of ice 1 of variable thickness that is typically covered by snow 5. As may be seen with additional reference to FIG. 2, an undesirable layer of ice 4 typically forms at the top of the column of water 6 within hole 2. The time required for ice layer 4 to form is a function of the water temperature at the top of the column of water 6, as well as the ambient wind and temperature conditions.

FIG. 3 illustrates the general temperature gradient of the column of water 6 within ice fishing hole 2. It will be appreciated that the water below the layer of ice 1 and, thus, the water at the bottom of the column of water 6 is at a temperature higher than the temperature at which water becomes ice; therefore it is not frozen. Since a large volume of water that will not freeze exists only a few molecules below an ice layer formed on a lake or at the surface of an ice fishing hole, it is desirable to replace the colder water at the surface of the column of water 6 within hole 2 with the warmer water from the bottom of the column of water 6, as illustrated in FIG. 3, to prevent the formation of surface ice.

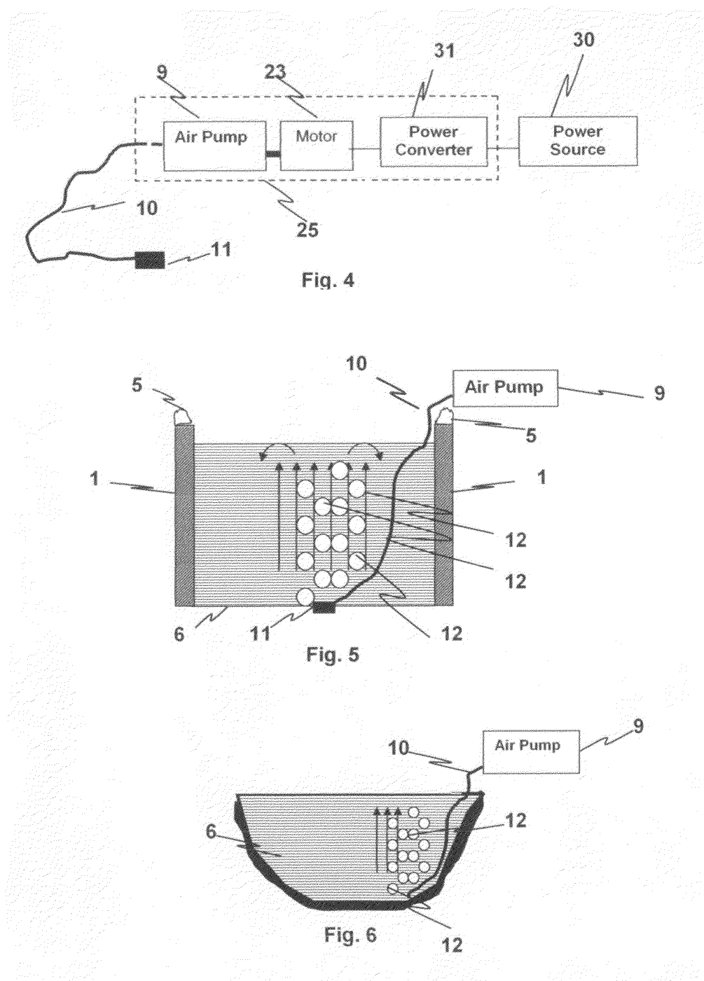

Referring now to FIG. 4, there is shown a block diagram of the components that form the apparatus of the present invention. An air pump 9 is driven by an electric motor 23 to provide a pressurized source of air of adjustable volume to a conventional bubbler or other air disbursement device 11 through a flexible tube 10. Air pump 9 may be selected from many commercially available air pumps of varying size and capacity. Likewise, motor 23 may be appropriately selected from a large offering of off-the-shelf motors. Alternatively, air pump 9 and motor 23 may be integrally formed as a single component. A conventional external power source 30, such as a battery, an AC power source, or a solar panel may be employed to supply operating power to motor 23. Conventional power conversion circuitry 31 is employed to convert power from external power source 30 for use by motor 23. Air pump 9, motor 23, and power conversion circuitry 31 are preferably mounted within an enclosure 25 to protect them from the environmental elements. Other devices commonly used by ice fisherman, such as fish finders, for example, may be mounted in close proximity to enclosure 25. Power conversion circuitry 31 is preferably designed to generate sufficient heat within the enclosure to insure proper functioning of motor 23 and air pump 9 at very low ambient temperatures.

Operation of the apparatus of the present invention may be readily understood with reference to FIG. 5. Enclosure 25, containing air pump 9, is conveniently positioned adjacent a previously-drilled ice fishing hole with air tube 10 extending downward into the column of water 6 such that bubbler 11 is positioned near the bottom thereof. Bubbler 11 may be retained in a desired position by adjusting the length of air tube 10, selective weighting, or by attaching it to the cable portion of a sonar transducer of the type commonly used by ice fisherman. During operation of air pump 9, air bubbles 12 are emitted from bubbler 11 and immediately rise to the surface of the column of water 6. As previously stated, the rising air bubbles 12 produce an upward circulation of warmer water from the bottom of the column of water 6 to the surface thereof, thus preventing the undesirable formation of ice on the surface of the column of water 6.

We claim:

1. Ice fishing apparatus for preventing the formation of ice on the surface of a column of water within a hole previously drilled through a layer of ice formed on a body of water, comprising:
an air pump for producing a pressurized source of air;
tube means coupled to said air pump for conveying air produced by said air pump; and
air disbursement means coupled to a distal end of said tube means, said air disbursement means being positioned proximate a bottom end of said column of water, said air disbursement means emitting air bubbles into said column of water.

2. Ice fishing apparatus as in claim 1, further comprising a motor for driving said air pump.

3. Ice fishing apparatus as in claim 2, further comprising:
an external power source; and
power conversion circuitry connected to said external power source and to said motor for supplying operating power to said motor.

4. Ice fishing apparatus as in claim 3, further comprising enclosure means for containing said air pump, said motor, and said power conversion circuitry and for protecting said air pump, said motor, and said power conversion circuitry from exposure to external wind and temperature conditions.

5. Ice fishing apparatus as in claim 1, wherein said tube means comprises a length of flexible tubing.

6. Ice fishing apparatus as in claim 3, wherein said external power source comprises one or more batteries.

7. Ice fishing apparatus as in claim 3, wherein said external power source comprises an AC power source.

8. Ice fishing apparatus as in claim 3, wherein said external power source comprises a solar power source.

9. Ice fishing apparatus as in claim 1, further comprising:
an external power source; and
power conversion circuitry connected to said external power source and to said air pump for supplying operating power to said air pump.

10. Ice fishing apparatus as in claim 4, wherein said power conversion circuitry includes heat generation means for maintaining an operating temperature within said enclosure means.

11. Ice fishing apparatus as in claim 1, wherein said pressurized source of air is adjustable in volume.

12. Apparatus for preventing the formation of ice on the surface of a contained volume of water, comprising:
an air pump for producing a pressurized source of air;
tube means coupled to said air pump for conveying air produced by said air pump; and
air disbursement means coupled to a distal end of said tube means, said air disbursement means being positioned within a lower portion of said contained volume of water, said air disbursement means emitting air bubbles into said contained volume of water.

13. A method for preventing the formation of ice on the surface of a column of water within an ice fishing hole previously drilled through a layer of ice formed on a body of water by injecting air into said column of water, comprising:
providing a pressurized source of air that is adjustable in volume;
providing means for conveying air from said pressurized source of air;
providing air disbursement means coupled to a distal end of said means for conveying air;
positioning said air disbursement means proximate a bottom end of said column of water; and
initiating operation of said pressurized source of air to cause air bubbles to be emitted from said air disbursement means into said column of water.

14. A method for preventing the formation of ice on the surface of a contained volume of water by injecting air into said volume of water, comprising:
providing a pressurized source of air that is adjustable in volume;
providing means for conveying air from said pressurized source of air;
providing air disbursement means coupled to a distal end of said means for conveying air;
positioning said air disbursement means within a lower portion of said contained volume of water; and
initiating operation of said pressurized source of air to cause air bubbles to be emitted from said air disbursement means into said lower portion of said contained volume of water.
